(19) United States
(12) Patent Application Publication
(10) Pub. No.: US 2022/0322177 A1
(43) Pub. Date: Oct. 6, 2022

(54) SIGNALING LAYER 1/LAYER 2 INTER-CELL MOBILITY CAPABILITY

(71) Applicant: QUALCOMM Incorporated, San Diego, CA (US)

(72) Inventors: Jelena DAMNJANOVIC, Del Mar, CA (US); Tao LUO, San Diego, CA (US); Yan ZHOU, San Diego, CA (US)

(21) Appl. No.: 17/656,705

(22) Filed: Mar. 28, 2022

Related U.S. Application Data
(60) Provisional application No. 63/169,659, filed on Apr. 1, 2021.

(51) Int. Cl. H04W 36/04; H04W 36/00; H04W 8/24

(52) U.S. Cl. CPC H04W 36/04; H04W 36/0061; H04W 8/24

(57) ABSTRACT

Various aspects of the present disclosure generally relate to wireless communication. In some aspects, a user equipment (UE) may transmit, and a network node may receive, capability information that indicates whether the UE supports Layer 1 or Layer 2 (L1/L2) inter-cell mobility. The network node may transmit, and the UE may receive, radio resource control signaling configuring one or more cells for L1/L2 inter-cell mobility based at least in part on the capability information. The network node may transmit, and the UE may receive, L1/L2 signaling triggering inter-cell mobility based at least in part on the capability information indicating that the UE supports L1/L2 inter-cell mobility. Numerous other aspects are described.

### CROSS-REFERENCE TO RELATED APPLICATION

This Patent application claims priority to U.S. Provisional Patent Application No. 63/169,659, filed on Apr. 1, 2021, entitled “SIGNALING LAYER 1/LAYER 2 INTER-CELL MOBILITY CAPABILITY,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses associated with signaling a Layer 1/Layer 2 (L1/L2) inter-cell mobility capability.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes transmitting, to a network node, capability information that indicates whether the UE supports Layer 1 or Layer 2 (L1/L2) inter-cell mobility; receiving radio resource control (RRC) signaling configuring one or more cells for L1/L2 inter-cell mobility based at least in part on the capability information; and receiving L1/L2 signaling triggering inter-cell mobility based at least in part on the capability information indicating that the UE supports L1/L2 inter-cell mobility.

In some aspects, a method of wireless communication performed by a network node includes receiving, from a UE, capability information that indicates whether the UE supports L1/L2 inter-cell mobility; transmitting, to the UE, RRC signaling configuring one or more cells for L1/L2 inter-cell mobility based at least in part on the capability information; and transmitting, to the UE, L1/L2 signaling triggering inter-cell mobility for the UE based at least in part on the capability information indicating that the UE supports L1/L2 inter-cell mobility.

In some aspects, a UE for wireless communication includes a memory and one or more processors, coupled to the memory, configured to: transmit, to a network node, capability information that indicates whether the UE supports L1/L2 inter-cell mobility; receive RRC signaling configuring one or more cells for L1/L2 inter-cell mobility based at least in part on the capability information; and receive L1/L2 signaling triggering inter-cell mobility based at least in part on the capability information indicating that the UE supports L1/L2 inter-cell mobility.

In some aspects, a network node for wireless communication includes a memory and one or more processors, coupled to the memory, configured to: receive, from a UE, capability information that indicates whether the UE supports L1/L2 inter-cell mobility; transmit, to the UE, RRC signaling configuring one or more cells for L1/L2 inter-cell mobility based at least in part on the capability information; and transmit, to the UE, L1/L2 signaling triggering inter-cell mobility for the UE based at least in part on the capability information indicating that the UE supports L1/L2 inter-cell mobility.

In some aspects, a non-transitory computer-readable medium storing a set of instructions for wireless communication includes one or more instructions that, when executed by one or more processors of a UE, cause the UE to: transmit, to a network node, capability information that indicates whether the UE supports L1/L2 inter-cell mobility; receive RRC signaling configuring one or more cells for L1/L2 inter-cell mobility based at least in part on the capability information; and receive L1/L2 signaling triggering inter-cell mobility based at least in part on the capability information indicating that the UE supports L1/L2 inter-cell mobility.

In some aspects, a non-transitory computer-readable medium storing a set of instructions for wireless communication includes one or more instructions that, when executed by one or more processors of a network node, cause the network node to: receive, from a UE, capability information that indicates whether the UE supports L1/L2 inter-cell mobility; transmit, to the UE, RRC signaling configuring one or more cells for L1/L2 inter-cell mobility based at least in part on the capability information; and transmit, to the UE, L1/L2 signaling triggering inter-cell mobility for the UE based at least in part on the capability information indicating that the UE supports L1/L2 inter-cell mobility.

In some aspects, an apparatus for wireless communication includes means for transmitting, to a network node, capability information that indicates whether the apparatus supports L1/L2 inter-cell mobility; means for receiving RRC signaling configuring one or more cells for L1/L2 inter-cell mobility based at least in part on the capability information; and means for receiving L1/L2 signaling triggering inter-cell mobility based at least in part on the capability information indicating that the apparatus supports L1/L2 inter-cell mobility.

In some aspects, an apparatus for wireless communication includes means for receiving, from a UE, capability information that indicates whether the UE supports L1/L2 inter-cell mobility; means for transmitting, to the UE, RRC signaling configuring one or more cells for L1/L2 inter-cell mobility based at least in part on the capability information; and means for transmitting, to the UE, L1/L2 signaling triggering inter-cell mobility for the UE based at least in part on the capability information indicating that the UE supports L1/L2 inter-cell mobility.

Aspects generally include a method, apparatus, system, computer program product, non-transitory computer-readable medium, user equipment, base station, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example disaggregated base station architecture, in accordance with the present disclosure.

FIGS. 4A-4B are diagrams illustrating examples of Layer 1/Layer 2 (L1/L2) inter-cell mobility, in accordance with the present disclosure.

FIG. 5 is a diagram illustrating an example associated with signaling an L1/L2 inter-cell mobility capability, in accordance with the present disclosure.

FIGS. 6-7 are diagrams illustrating example processes associated with signaling an L1/L2 inter-cell mobility capability, in accordance with the present disclosure.

FIGS. 8-9 are block diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

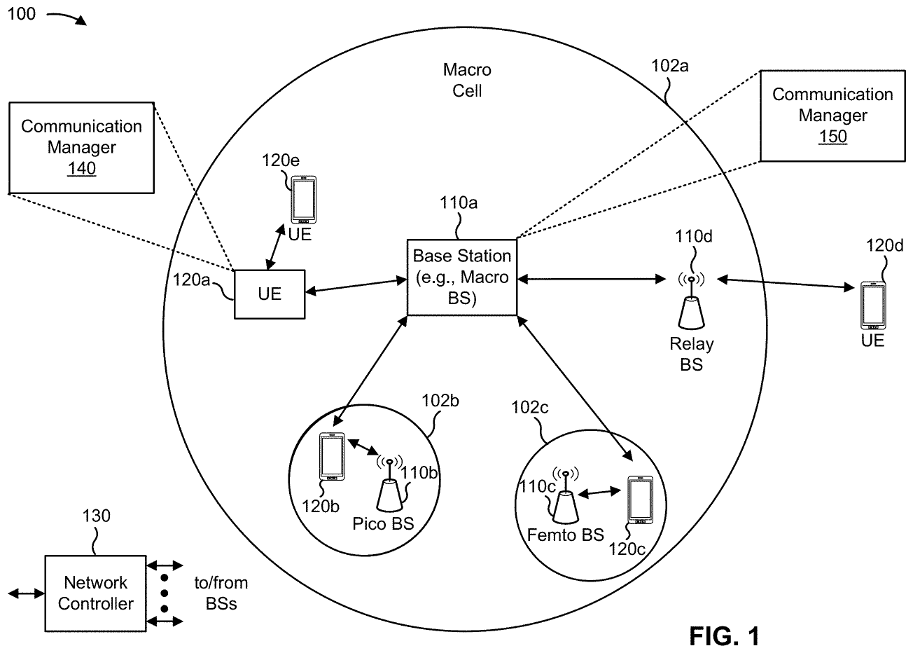

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may transmit, to a network node, capability information that indicates whether the UE 120 supports Layer 1 or Layer 2 (L1/L2) inter-cell mobility; receive radio resource control (RRC) signaling configuring one or more cells for L1/L2 inter-cell mobility based at least in part on the capability information; and receive L1/L2 signaling triggering inter-cell mobility based at least in part on the capability information indicating that the UE 120 supports L1/L2 inter-cell mobility. Additionally, or alternatively, the communication manager 140 may perform one or more other operations described herein.

In some aspects, the base station 110 may include a communication manager 150. As described in more detail elsewhere herein, the communication manager 150 may receive, from a UE 120, capability information that indicates whether the UE 120 supports L1/L2 inter-cell mobility; transmit, to the UE 120, RRC signaling configuring one or more cells for L1/L2 inter-cell mobility based at least in part on the capability information; and transmit, to the UE 120, L1/L2 signaling triggering inter-cell mobility for the UE 120 based at least in part on the capability information indicating that the UE 120 supports L1/L2 inter-cell mobility. Additionally, or alternatively, the communication manager 150 may perform one or more other operations described herein.

As indicated above, FIG. 1 is provided as an example. Other examples may differ from what is described with regard to FIG. 1.

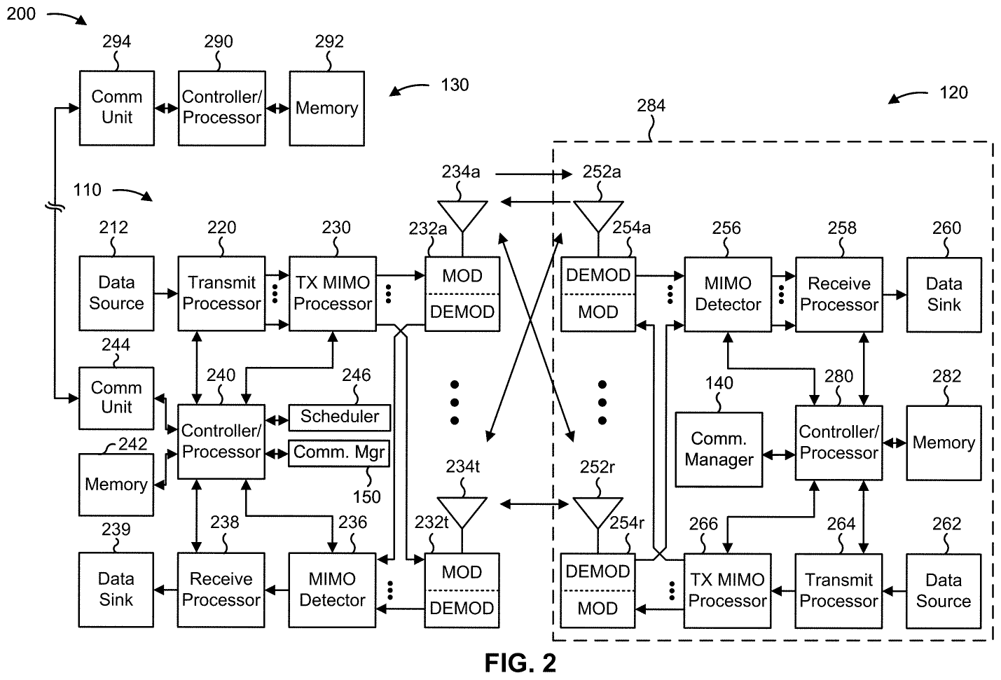

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS.).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS.).

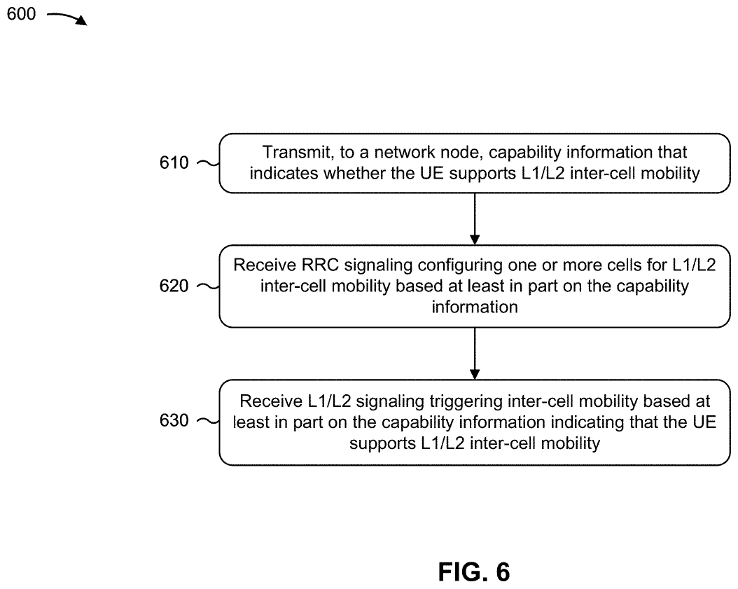

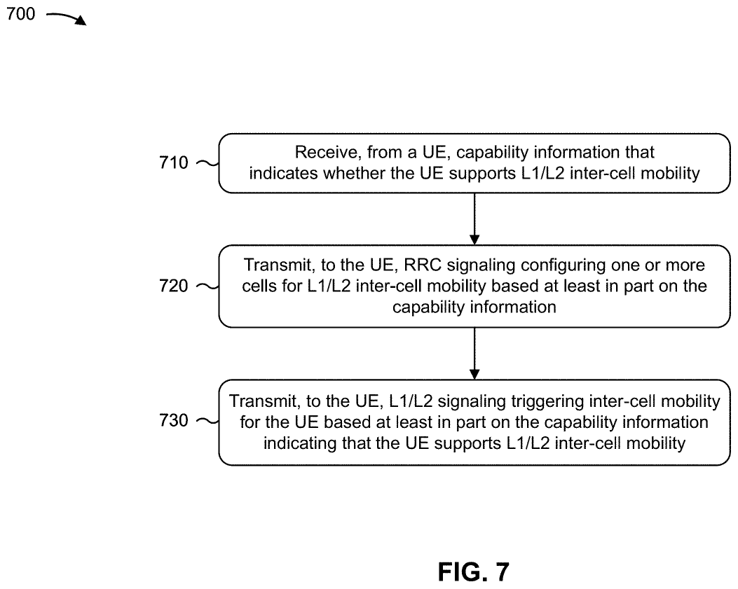

The controller/processor 240 of the base station 110, the controller/processor 280 of the UE 120, and/or any other component(s) of FIG. 2 may perform one or more techniques associated with signaling a Layer 1 or Layer 2 (L1/L2) inter-cell mobility capability, as described in more detail elsewhere herein. For example, the controller/processor 240 of the base station 110, the controller/processor 280 of the UE 120, and/or any other component(s) of FIG. 2 may perform or direct operations of, for example, process 600 of FIG. 6, process 700 of FIG. 7, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 600 of FIG. 6, process 700 of FIG. 7, and/or other processes as described herein. In some examples, executing instructions may include running the instructions, converting the instructions, compiling the instructions, and/or interpreting the instructions, among other examples.

In some aspects, the UE 120 includes means for transmitting, to the base station 110, capability information that indicates whether the UE 120 supports L1/L2 inter-cell mobility; means for RRC signaling configuring one or more cells for L1/L2 inter-cell mobility based at least in part on the capability information; and/or means for receiving L1/L2 signaling triggering inter-cell mobility based at least in part on the capability information indicating that the UE 120 supports L1/L2 inter-cell mobility. The means for the UE 120 to perform operations described herein may include, for example, one or more of communication manager 140, antenna 252, demodulator 254, MIMO detector 256, receive processor 258, transmit processor 264, TX MIMO processor 266, modulator 254, controller/processor 280, or memory 282.

In some aspects, the base station 110 includes means for receiving, from the UE 120, capability information that indicates whether the UE 120 supports L1/L2 inter-cell mobility; means for transmitting, to the UE 120, RRC signaling configuring one or more cells for L1/L2 inter-cell mobility based at least in part on the capability information; and/or means for transmitting, to the UE 120, L1/L2 signaling triggering inter-cell mobility for the UE 120 based at least in part on the capability information indicating that the UE 120 supports L1/L2 inter-cell mobility. The means for the base station 110 to perform operations described herein may include, for example, one or more of communication manager 150, transmit processor 220, TX MIMO processor 230, modulator 232, antenna 234, demodulator 232, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

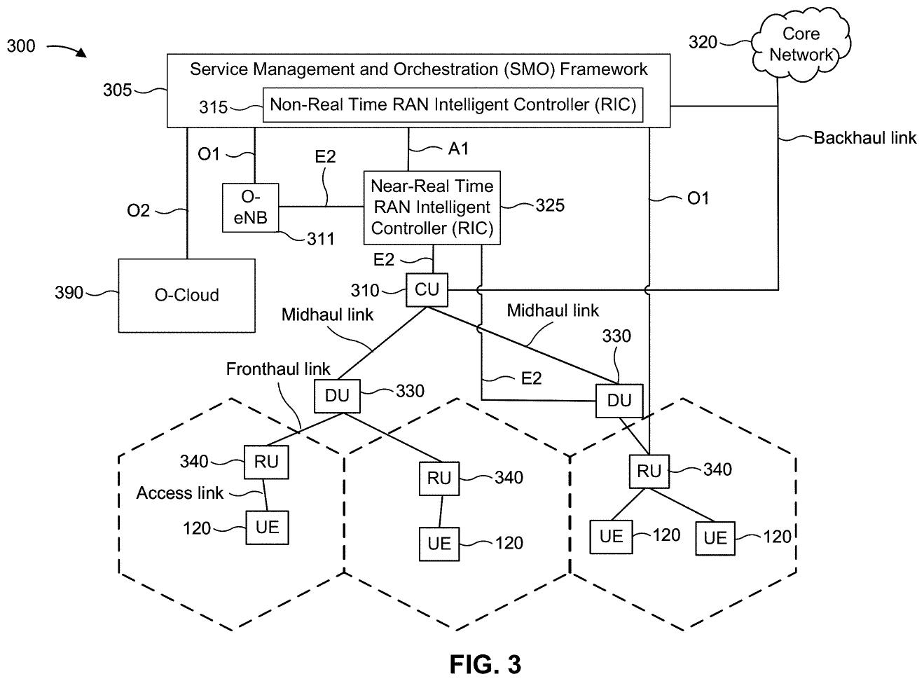

FIG. 3 is a diagram illustrating an example 300 disaggregated base station architecture, in accordance with the present disclosure.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station (BS, e.g., base station 110), or one or more units (or one or more components) performing base station functionality, may be implemented in an aggregated or disaggregated architecture. For example, a BS (such as a Node B (NB), eNB, NR BS, 5G NB, access point (AP), a TRP, a cell, or the like) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual centralized unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an O-RAN (such as the network configuration sponsored by the O-RAN Alliance), or a virtualized radio access network (vRAN), also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station architecture shown in FIG. 3 may include one or more CUs 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUs 310, the DUs 330, the RUs 340), as well as the Near-RT RICs 325, the Non-RT RICs 315, and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include RRC, packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit—User Plane (CU-UP)), control plane functionality (e.g., Central Unit—Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low-PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with regard to FIG. 3.

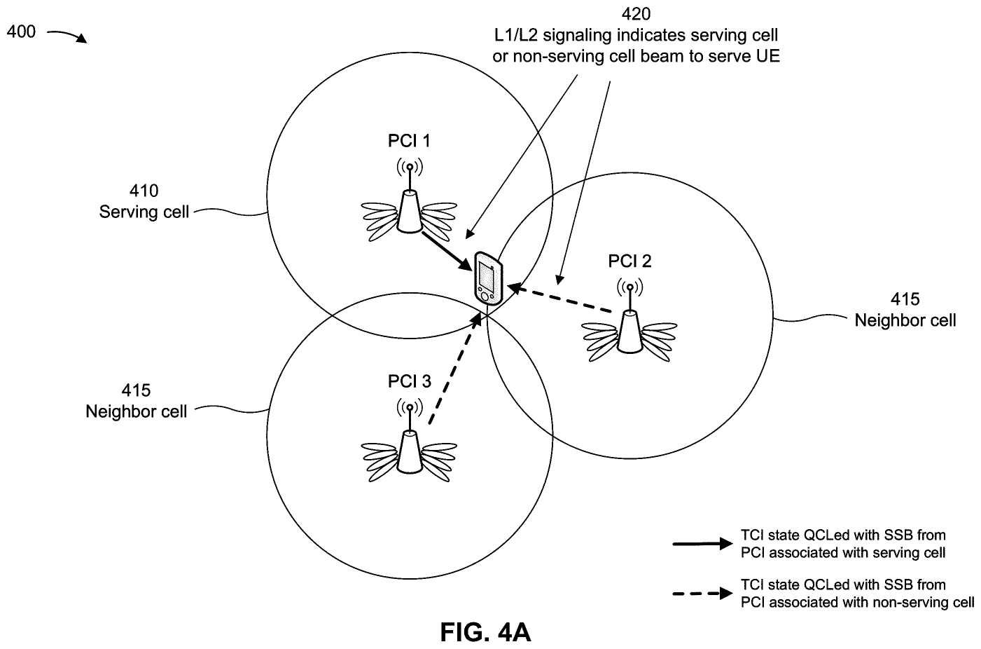

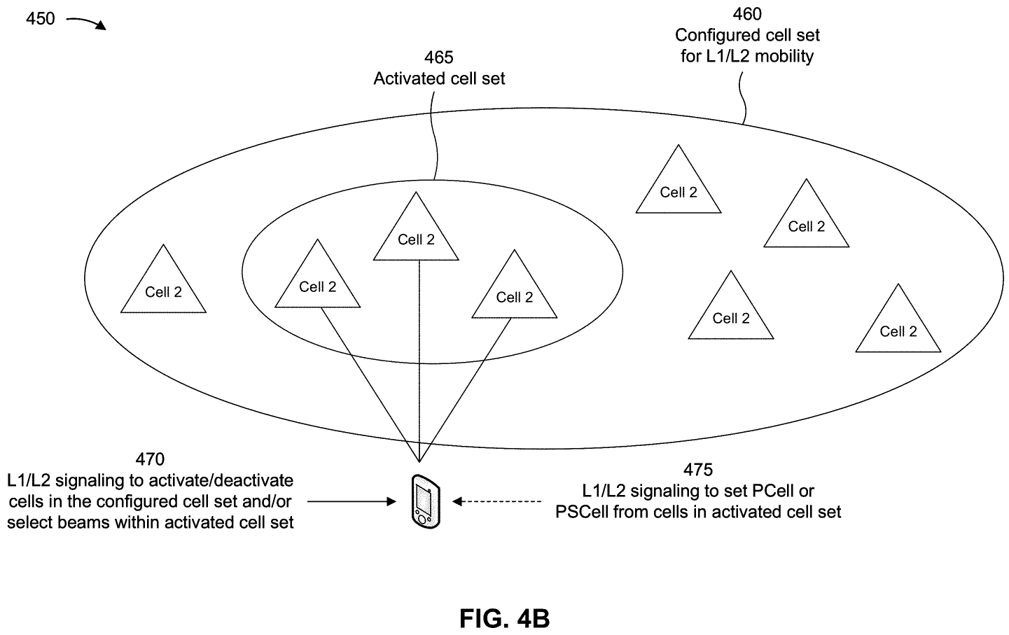

FIGS. 4A-4B are diagrams illustrating examples 400, 450 of L1/L2 inter-cell mobility, in accordance with the present disclosure.

In a wireless network, such as an NR network, a UE and a network node (e.g., a base station or one or more units or components performing base station functionality) may communicate on an access link using directional links (e.g., using high-dimensional phased arrays) to benefit from a beamforming gain and/or to maintain acceptable communication quality. The directional links, however, typically require fine alignment of transmit and receive beams, which may be achieved through a set of operations referred to as beam management and/or beam selection, among other examples. Further, a wireless network may support multi-beam operation in a relatively high carrier frequency (e.g., within FR2), which may be associated with harsher propagation conditions than comparatively lower carrier frequencies. For example, relative to a sub-6 gigahertz (GHz) band, signals propagating in a millimeter wave frequency band may suffer from increased pathloss and severe channel intermittency, and/or may be blocked by objects commonly present in an environment surrounding the UE (e.g., a building, a tree, and/or a body of a user, among other examples). Accordingly, beam management is particularly important for multi-beam operation in a relatively high carrier frequency.

One possible enhancement for multi-beam operation in a higher carrier frequency is facilitation of efficient (e.g., low latency and low overhead) downlink and/or uplink beam management to support higher L1/L2-centric inter-cell mobility. Accordingly, one goal for L1/L2-centric inter-cell mobility is to enable a UE to perform a cell switch via dynamic control signaling at lower layers (e.g., downlink control information (DCI) for L1 signaling or a MAC control element (MAC-CE) for L2 signaling) rather than semi-static Layer 3 (L3) RRC signaling in order to reduce latency, reduce overhead, and/or otherwise increase efficiency of the cell switch.

For example, FIG. 4A illustrates an example 400 of a first L1/L2 inter-cell mobility technique, which may be referred to as inter-cell mobility scheme 1, beam-based inter-cell mobility, dynamic point selection based inter-cell mobility, and/or non-serving cell-based inter-cell mobility, among other examples. As described in further detail herein, the first L1/L2 inter-cell mobility technique may enable a network node to use L1 signaling (e.g., DCI) or L2 signaling (e.g., a MAC-CE) to indicate that a UE is to communicate on an access link using a beam from a serving cell or a non-serving cell. For example, in a wireless network where L1/L2 inter-cell mobility is not supported (e.g., cell switches are triggered only by an L3 handover), beam selection for control information and for data is typically limited to beams within a physical cell identity (PCI) associated with a serving cell. In contrast, in a wireless network that supports the first L1/L2 inter-cell mobility technique (e.g., as shown in FIG. 4A), beam selection for control and data may be expanded to include any beams within a serving cell 410 or one or more non-serving neighbor cells 415 configured for L1/L2 inter-cell mobility.

For example, in the first L1/L2 inter-cell mobility technique shown in FIG. 4A, a UE may be configured with a single serving cell 410, and the UE may be further configured with a neighbor cell set that includes one or more non-serving cells 415 configured for L1/L2 inter-cell mobility. In general, the serving cell 410 and the non-serving cells 415 that are configured for L1/L2 inter-cell mobility may be associated with a common CU and a common DU, or the serving cell 410 and the non-serving cells 415 configured for L1/L2 inter-cell mobility may be associated with a common CU and different DUs. In some aspects, as shown by reference number 420, a base station may trigger L1/L2 inter-cell mobility for a UE using L1/L2 signaling (e.g., DCI or a MAC-CE) that indicates a selected transmission configuration indication (TCI) state quasi co-located (QCLed) with a reference signal (e.g., a synchronization signal block (SSB)) associated with a PCI. For example, in FIG. 4A, the UE may be communicating with the serving cell 410 using a TCI state that is QCLed with an SSB from a PCI associated with the serving cell 410 (e.g., shown as PCI 1 in FIG. 4A), and L1/L2 signaling may trigger inter-cell mobility by indicating that the UE is to switch to communicating using a TCI state that is QCLed with an SSB from a PCI associated with a non-serving neighbor cell 415 (e.g., shown as PCI 2 in FIG. 4A). Accordingly, in the first L1/L2 inter-cell mobility technique, the network node (e.g., the common CU controlling the serving cell 410 and the non-serving neighbor cells 415) may use L1/L2 signaling to select a beam from either the serving cell 410 or a non-serving neighbor cell 415 to serve the UE.

In this way, relative to restricting L1/L2 beam selection to beams within the serving cell 410, the first L1/L2 inter-cell mobility technique may be more robust against blocking and may provide more opportunities for higher rank spatial division multiplexing across different cells. However, the first L1/L2 inter-cell mobility technique does not enable support for changing a primary cell (PCell) or a primary secondary cell (PSCell) for a UE. Rather, in the first L1/L2 inter-cell mobility technique, triggering a Pcell or PSCell change is performed via a legacy L3 handover using RRC signaling. In this respect, the first L1/L2 inter-cell mobility technique is associated with a limitation that L1/L2 signaling can only be used to indicate a beam from the serving cell 410 or a configured neighbor cell 415 while the UE is in the coverage area of the serving cell 410 because L1/L2 signaling cannot be used to change the Pcell or PSCell. Accordingly, FIG. 4B illustrates an example 450 of a second L1/L2 inter-cell mobility technique, which may be referred to as inter-cell mobility scheme 2 and/or serving cell-based inter-cell mobility, among other examples. As described in further detail herein, the second L1/L2 inter-cell mobility technique may enable a network node to use L1/L2 signaling (e.g., DCI or a MAC-CE) to indicate control information associated with an activated cell set and/or a deactivated cell set and/or to indicate a change to a PCell or a PSCell within the activated cell set.

For example, as shown in FIG. 4B, the second L1/L2 inter-cell mobility technique may use mechanisms that are generally similar to carrier aggregation to enable L1/L2 inter-cell mobility, except that different cells configured for L1/L2 inter-cell mobility may be on the same carrier frequency. As shown in FIG. 4B, a network node may configure a cell set 460 for L1/L2 inter-cell mobility (e.g., using RRC signaling). As further shown, an activated cell set 465 may include one or more cells in the configured cell set 460 that are activated and ready to use for data and/or control transfer. Accordingly, in the second L1/L2 inter-cell mobility technique, a deactivated cell set may include one or more cells that are included in the cell set 460 configured for L1/L2 inter-cell mobility but are not included in the activated cell set 465. However, the cells that are included in the deactivated cell set can be readily activated, and thereby added to the activated cell set 465, using L1/L2 signaling. Accordingly, as shown by reference number 470, L1/L2 signaling can be used for mobility management of the activated cell set 465. For example, in some aspects, L1/L2 signaling can be used to activate cells within the configured cell set 460 (e.g., to add cells to the activated cell set 465), to deactivate cells in the activated cell set 465, and/or to select beams within the cells included in the activated cell set 465. In this way, the second L1/L2 inter-cell mobility technique may enable seamless mobility among the cells included in the activated cell set 465 using L1/L2 signaling (e.g., using beam management techniques).

Furthermore, as shown by reference number 475, the second L1/L2 inter-cell mobility technique enables using L1/L2 signaling to set or change a PCell or PSCell from the cells that are included in the activated cell set 465. Additionally, or alternatively, when the cell to become the new Pcell or PSCell is in the deactivated cell set (e.g., is included in the cell set 460 configured for L1/L2 mobility but not the activated cell set 465), L1/L2 signaling can be used to move the cell from the deactivated cell set to the activated cell set 465 before further L1/L2 signaling is used to set the cell as the new Pcell or PSCell. However, in the second L1/L2 inter-cell mobility techniques, an L3 handover (using RRC signaling) is used to change the Pcell or PSCell when the new Pcell or PSCell is not included in the cell set 460 configured for L1/L2 inter-cell mobility. In such cases, RRC signaling associated with the L3 handover may be used to update the cells included in the cell set 460 that is configured for L1/L2 inter-cell mobility.

Accordingly, as described herein, L1/L2 inter-cell mobility can provide more efficient cell switching to support multi-beam operation, enabling lower latency and reduced overhead by using L1 signaling (e.g., DCI) and/or L2 signaling (e.g., a MAC-CE) rather than L3 signaling (e.g., RRC) to change the beam(s) used by a UE to transfer control information and/or data over an access link. However, UEs may not universally support L1/L2 inter-cell mobility. For example, legacy UEs may support only legacy L3 handovers using RRC signaling, while other UEs may support either or both of the L1/L2 inter-cell mobility techniques described in further detail above. Furthermore, different UEs may offer varying levels of support for different features associated with one or more L1/L2 inter-cell mobility techniques. For example, one or more UEs that support using the second L1/L2 inter-cell mobility technique to activate/deactivate cells included in the activated cell set 465 and to select beams within the activated cell set 465 may lack support for changing the Pcell or PSCell using L1/L2 signaling. Furthermore, a wireless network may support one, both, or neither of the L1/L2 inter-cell mobility techniques. Accordingly, in a wireless network that supports one or both of the L1/L2 inter-cell mobility techniques, a network node may need to know the L1/L2 inter-cell mobility capabilities of a UE in order to properly configure (or not configure) L1/L2 inter-cell mobility for the UE.

Some aspects described herein provide techniques and apparatuses for signaling an L1/L2 inter-cell mobility capability. For example, a UE may transmit, to a network node, capability information that indicates whether the UE supports L1/L2 inter-cell mobility, and if so, which L1/L2 inter-cell mobility technique(s) the UE supports. Furthermore, for any L1/L2 inter-cell mobility techniques that have one or more sub-features (e.g., features to change a PCell or PSCell using L1/L2 signaling), the capability information may indicate whether the UE supports the one or more sub-features. In addition, in some aspects, the capability information may provide more granular detail related to the L1/L2 inter-cell mobility capabilities of the UE, such as a maximum number of supported serving cells, a maximum number of supported non-serving cells, and/or a maximum number of supported beams, among other examples. In this way, when the UE supports L1/L2 inter-cell mobility, the network node may appropriately configure one or more serving cells and/or non-serving cells for L1/L2 inter-cell mobility, which may enable cell switching via a lower layer (e.g., L1 and/or L2) signaling, thereby increasing efficiency (e.g., by reducing latency and/or overhead) of beam management in support of L1/L2-centric inter-cell mobility.

As indicated above, FIGS. 4A-4B are provided as examples. Other examples may differ from what is described with regard to FIGS. 4A-4B.

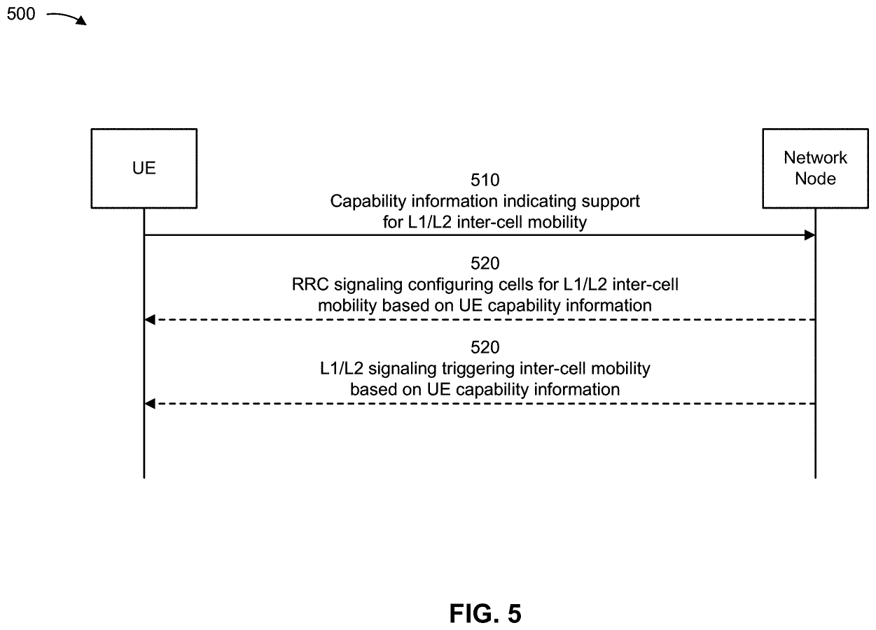

FIG. 5 is a diagram illustrating an example 500 associated with signaling an L1/L2 inter-cell mobility capability, in accordance with the present disclosure. As shown in FIG. 5, example 500 includes communication between a UE (e.g., UE 120) and a network node (e.g., base station 110 or one or more units or components performing functionality of base station 110, such as a CU, a DU, or an RU). In some aspects, the UE and the network node may be included in a wireless network, such as wireless network 100. The UE and the network node may communicate via a wireless access link, which may include an uplink and a downlink. Furthermore, as described herein, the wireless network in which the UE and the network node communicate may support one or more L1/L2 inter-cell mobility techniques. For example, the wireless network may support the beam-based or non-serving cell-based L1/L2 inter-cell mobility technique described above with reference to FIG. 4A, the serving cell-based L1/L2 inter-cell mobility technique described above with reference to FIG. 4B, or a combination thereof.

As shown in FIG. 5, and by reference number 510, the UE may transmit, and the network node may receive, capability information that indicates a capability of the UE to support L1/L2 inter-cell mobility (e.g., using RRC signaling). For example, in some aspects, the capability information may include a bit, a flag, an information element, or other suitable information to indicate whether the UE supports L1/L2 inter-cell mobility or lacks support for L1/L2 inter-cell mobility. Furthermore, in cases where the UE supports L1/L2 inter-cell mobility, the capability information may further indicate whether the UE supports only a first L1/L2 inter-cell mobility technique that enables using L1/L2 signaling to indicate that the UE is to communicate using a beam from a serving cell or a non-serving cell (e.g., the technique described above with respect to FIG. 4A), only a second L1/L2 inter-cell mobility technique that enables using L1/L2 signaling to indicate control information associated with an activated cell set or a deactivated cell set and/or change a PCell or PSCell for the UE (e.g., the technique described above with respect to FIG. 4B), or both techniques. Accordingly, as described herein, the capability information may be configured to indicate whether the UE supports L1/L2 inter-cell mobility, and if so, which technique(s) the UE supports.

In some aspects, in cases where the UE supports one or more L1/L2 inter-cell mobility techniques, the capability information transmitted to the network node may further indicate one or more parameters related to the supported technique(s). For example, in cases where the UE supports the beam-based inter-cell mobility or non-serving cell-based inter-cell mobility technique described above with reference to FIG. 4A, the capability information may further indicate a maximum number of non-serving cells that the UE supports configuring for L1/L2 inter-cell mobility and/or a maximum number of beams supported by the UE. Additionally, or alternatively, in cases where the UE supports the serving cell-based inter-cell mobility technique described above with reference to FIG. 4B, the capability information may further indicate a maximum number of serving cells that the UE supports including in the configured cell set and/or the activated cell set and/or the maximum number of beams supported by the UE. In this way, the network node may use the capability information indicated by the UE to configure serving cells, non-serving cells, and/or beams for L1/L2 mobility.

Furthermore, in cases where the UE supports the serving cell-based inter-cell mobility technique described above with reference to FIG. 4B, the capability information may further indicate whether the UE supports using L1/L2 signaling to dynamically change the PCell or PSCell that is configured for the UE. For example, in the serving cell-based inter-cell mobility technique, L1/L2 signaling can generally be used to activate or deactivate cells within a cell set that is configured for L1/L2 mobility, and L1/L2 signaling can be further used to change the PCell or PSCell within the cells that are included in the activated cell set. Accordingly, in some aspects, the capability information may indicate whether the UE has a capability to support changing a PCell or PSCell using L1/L2 signaling or only supports using L1/L2 signaling to activate or deactivate cells within the configured cell set and to select beams within the activated cell set. In some aspects, in cases where the UE has the capability to support changing a PCell or PSCell using L1/L2 signaling, the capability information may further indicate the number of PCells or PSCells that can be configured for the UE.

As further shown in FIG. 5, and by reference number 520, the network node may transmit, and the UE may receive, RRC signaling that configures one or more cells for L1/L2 inter-cell mobility based on the UE capability information indicating support for one or more L1/L2 inter-cell mobility techniques. For example, in cases where the UE supports the beam-based or non-serving cell-based L1/L2 inter-cell mobility technique, the RRC signaling may configure a single serving cell and may configure one or more non-serving neighbor cells for L1/L2 inter-cell mobility (e.g., to enable using subsequent L1/L2 signaling to select a beam from the serving cell or a non-serving neighbor cell to serve the UE). In such cases, the number of non-serving neighbor cells may be based on the UE capability information, which may indicate the maximum number of non-serving cells and/or beams that are supported by the UE. Additionally, or alternatively, in cases where the UE supports the serving cell-based L1/L2 inter-cell mobility technique, the RRC signaling may indicate a set of cells that are configured for L1/L2 inter-cell mobility such that subsequent L1/L2 signaling can be used to activate or deactivate one or more of the cells that are configured for L1/L2 inter-cell mobility, select beams within the activated cell set, and/or indicate one or more cells in the activated cell set that are configured as the PCell or PSCell for the UE. In such cases, the number of cells in the configured cell set and/or the activated cell set may be based on the UE capability information that indicates the maximum number of supported serving cells, the maximum number of supported serving cells in the activated cell set, and/or the maximum number of supported beams for the serving cell-based L1/L2 inter-cell mobility technique. Alternatively, in cases where the UE capability information indicates a lack of support for L1/L2 inter-cell mobility, the RRC signaling may not configure any cells for L1/L2 inter-cell mobility, and inter-cell mobility may be performed only using a legacy L3 handover (e.g., using RRC signaling).

As further shown in FIG. 5, and by reference number 520, the network node may transmit, and the UE may receive, L1/L2 signaling triggering inter-cell mobility for the UE based on the capability information indicating that the UE supports one or more L1/L2 inter-cell mobility techniques. For example, the L1/L2 signaling may include L1 signaling (e.g., DCI) or L2 signaling (e.g., a MAC-CE) to trigger inter-cell mobility for the UE based on the inter-cell mobility techniques supported by the UE. For example, in cases where the UE indicates support for the beam-based or non-serving cell-based inter-cell mobility technique, the L1/L2 signaling may include DCI or MAC-CE to select either a serving cell beam or a non-serving cell beam to serve the UE by indicating a TCI state that is QCLed with a reference signal from a PCI associated with the serving cell or a non-serving cell. Additionally, or alternatively, in cases where the UE indicates support for the serving cell-based inter-cell mobility technique, the L1/L2 signaling may include DCI or a MAC-CE that includes control information to add one or more cells that are configured for L1/L2 inter-cell mobility to an activated cell set, to remove one or more cells from the activated cell set and add the one or more cells to a deactivated cell set, and/or to select one or more beams from one or more of the cells included in the activated cell set. Additionally, or alternatively, in cases where the UE indicates support for using L1/L2 signaling to change the PCell or PSCell for the UE, the L1/L2 signaling may include DCI or a MAC-CE to select a PCell or PSCell from the one or more cells that are included in the activated cell set.

As indicated above, FIG. 5 is provided as an example. Other examples may differ from what is described with regard to FIG. 5.

FIG. 6 is a diagram illustrating an example process 600 performed, for example, by a UE, in accordance with the present disclosure. Example process 600 is an example where the UE (e.g., UE 120) performs operations associated with signaling an L1/L2 inter-cell mobility capability.

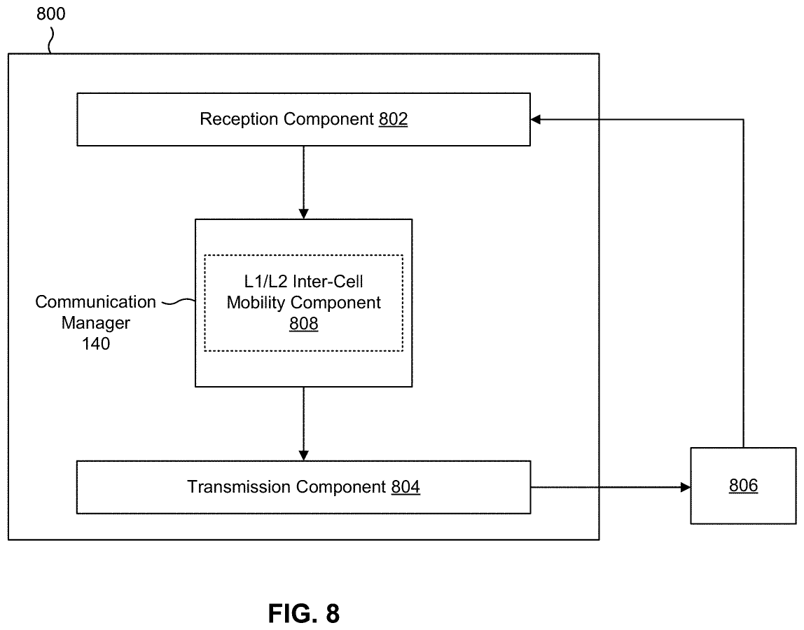

As shown in FIG. 6, in some aspects, process 600 may include transmitting, to a network node, capability information that indicates whether the UE supports L1/L2 inter-cell mobility (block 610). For example, the UE (e.g., using transmission component 804 and/or L1/L2 inter-cell mobility component 808, depicted in FIG. 8) may transmit, to a network node, capability information that indicates whether the UE supports L1/L2 inter-cell mobility, as described above.

As further shown in FIG. 6, in some aspects, process 600 may include receiving RRC signaling configuring one or more cells for L1/L2 inter-cell mobility based at least in part on the capability information (block 620). For example, the UE (e.g., using reception component 802 and/or L1/L2 inter-cell mobility component 808, depicted in FIG. 8) may receive RRC signaling configuring one or more cells for L1/L2 inter-cell mobility based at least in part on the capability information, as described above.

As further shown in FIG. 6, in some aspects, process 600 may include receiving L1/L2 signaling triggering inter-cell mobility based at least in part on the capability information indicating that the UE supports L1/L2 inter-cell mobility (block 630). For example, the UE (e.g., using reception component 802 and/or L1/L2 inter-cell mobility component 808, depicted in FIG. 8) may receive L1/L2 signaling triggering inter-cell mobility based at least in part on the capability information indicating that the UE supports L1/L2 inter-cell mobility, as described above.

Process 600 may include additional aspects, such as any single aspect or any combination of aspects described below and/or in connection with one or more other processes described elsewhere herein.

In a first aspect, the capability information further indicates whether the UE supports only a first L1/L2 inter-cell mobility technique, only a second L1/L2 inter-cell mobility technique, or both the first L1/L2 inter-cell mobility technique and the second L1/L2 inter-cell mobility technique.

In a second aspect, alone or in combination with the first aspect, support for the first L1/L2 inter-cell mobility technique enables the L1/L2 signaling to indicate that the UE is to communicate using a beam from a serving cell or a non-serving cell.

In a third aspect, alone or in combination with one or more of the first and second aspects, the capability information further indicates a maximum number of non-serving cells or a maximum number of beams supported by the UE based at least in part on the capability information indicating support for at least the first L1/L2 inter-cell mobility technique.

In a fourth aspect, alone or in combination with one or more of the first through third aspects, support for the second L1/L2 inter-cell mobility technique enables the L1/L2 signaling to indicate control information associated with a first cell set that includes one or more activated cells or a second cell set that includes one or more deactivated cells ready to be added to the first cell set.

In a fifth aspect, alone or in combination with one or more of the first through fourth aspects, the capability information further indicates a maximum number of serving cells or a maximum number of beams supported by the UE based at least in part on the capability information indicating support for at least the second L1/L2 inter-cell mobility technique.

In a sixth aspect, alone or in combination with one or more of the first through fifth aspects, the capability information further indicates a maximum number of serving cells or a maximum number of beams supported by the UE within an activated cell set based at least in part on the capability information indicating support for at least the second L1/L2 inter-cell mobility technique.

In a seventh aspect, alone or in combination with one or more of the first through sixth aspects, the capability information further indicates whether the UE supports using the L1/L2 signaling to indicate a PCell or a PSCell from a set including one or more activated cells.

In an eighth aspect, alone or in combination with one or more of the first through seventh aspects, the capability information further indicates a maximum number of activated cells that can be included in the set based at least in part on the capability information indicating that the UE supports using the L1/L2 signaling to indicate a PCell or a PSCell among the one or more activated cells.

In a ninth aspect, alone or in combination with one or more of the first through eighth aspects, the L1/L2 signaling includes DCI for L1 signaling or a MAC-CE for L2 signaling.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a network node, in accordance with the present disclosure. Example process 700 is an example where the network node (e.g., base station 110 or one or more units or components performing functionality of base station 110, such as a CU, a DU, or an RU) performs operations associated with signaling an L1/L2 inter-cell mobility capability.

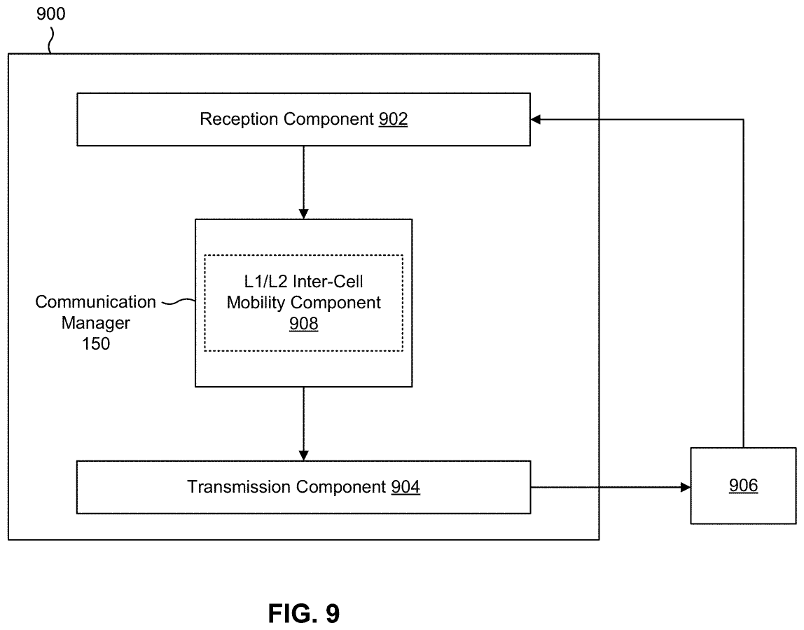

As shown in FIG. 7, in some aspects, process 700 may include receiving, from a UE, capability information that indicates whether the UE supports L1/L2 inter-cell mobility (block 710). For example, the network node (e.g., using reception component 902 and/or L1/L2 inter-cell mobility component 908, depicted in FIG. 9) may receive, from a UE, capability information that indicates whether the UE supports L1/L2 inter-cell mobility, as described above.

As further shown in FIG. 7, in some aspects, process 700 may include transmitting, to the UE, RRC signaling configuring one or more cells for L1/L2 inter-cell mobility based at least in part on the capability information (block 720). For example, the network node (e.g., using transmission component 904 and/or L1/L2 inter-cell mobility component 908, depicted in FIG. 9) may transmit, to the UE, RRC signaling configuring one or more cells for L1/L2 inter-cell mobility based at least in part on the capability information, as described above.

As further shown in FIG. 7, in some aspects, process 700 may include transmitting, to the UE, L1/L2 signaling triggering inter-cell mobility for the UE based at least in part on the capability information indicating that the UE supports L1/L2 inter-cell mobility (block 730). For example, the network node (e.g., using transmission component 904 and/or L1/L2 inter-cell mobility component 908, depicted in FIG. 9) may transmit, to the UE, L1/L2 signaling triggering inter-cell mobility for the UE based at least in part on the capability information indicating that the UE supports L1/L2 inter-cell mobility, as described above.

Process 700 may include additional aspects, such as any single aspect or any combination of aspects described below and/or in connection with one or more other processes described elsewhere herein.

In a first aspect, the capability information further indicates whether the UE supports only a first L1/L2 inter-cell mobility technique, only a second L1/L2 inter-cell mobility technique, or both the first L1/L2 inter-cell mobility technique and the second L1/L2 inter-cell mobility technique.

In a second aspect, alone or in combination with the first aspect, support for the first L1/L2 inter-cell mobility technique enables the L1/L2 signaling to indicate that the UE is to communicate using a beam from a serving cell or a non-serving cell.

In a third aspect, alone or in combination with one or more of the first and second aspects, the capability information further indicates a maximum number of non-serving cells or a maximum number of beams supported by the UE based at least in part on the capability information indicating support for at least the first L1/L2 inter-cell mobility technique.

In a fourth aspect, alone or in combination with one or more of the first through third aspects, support for the second L1/L2 inter-cell mobility technique enables the L1/L2 signaling to indicate control information associated with a first cell set that includes one or more activated cells or a second cell set that includes one or more deactivated cells ready to be added to the first cell set.

In a fifth aspect, alone or in combination with one or more of the first through fourth aspects, the capability information further indicates a maximum number of serving cells or a maximum number of beams supported by the UE based at least in part on the capability information indicating support for at least the second L1/L2 inter-cell mobility technique.

In a sixth aspect, alone or in combination with one or more of the first through fifth aspects, the capability information further indicates a maximum number of serving cells or a maximum number of beams supported by the UE within an activated cell set based at least in part on the capability information indicating support for at least the second L1/L2 inter-cell mobility technique.

In a seventh aspect, alone or in combination with one or more of the first through sixth aspects, the capability information further indicates whether the UE supports using the L1/L2 signaling to indicate a PCell or a PSCell from a set including one or more activated cells.

In an eighth aspect, alone or in combination with one or more of the first through seventh aspects, the capability information further indicates a maximum number of activated cells that can be included in the set based at least in part on the capability information indicating that the UE supports using the L1/L2 signaling to indicate a PCell or a PSCell among the one or more activated cells.

In a ninth aspect, alone or in combination with one or more of the first through eighth aspects, the L1/L2 signaling includes DCI for L1 signaling or a MAC-CE for L2 signaling.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a block diagram of an example apparatus 800 for wireless communication. The apparatus 800 may be a UE, or a UE may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a network node, or another wireless communication device) using the reception component 802 and the transmission component 804. As further shown, the apparatus 800 may include the communication manager 140. The communication manager 140 may include an L1/L2 inter-cell mobility component 808, among other examples.

In some aspects, the apparatus 800 may be configured to perform one or more operations described herein in connection with FIGS. 4A-4B and/or FIG. 4. Additionally, or alternatively, the apparatus 800 may be configured to perform one or more processes described herein, such as process 600 of FIG. 6. In some aspects, the apparatus 800 and/or one or more components shown in FIG. 8 may include one or more components of the UE described above in connection with FIG. 2. Additionally, or alternatively, one or more components shown in FIG. 8 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a demodulator, a MIMO detector, a receive processor, a controller/processor, a memory, or a combination thereof, of the UE described above in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modulator, a transmit MIMO processor, a transmit processor, a controller/processor, a memory, or a combination thereof, of the UE described above in connection with FIG. 2. In some aspects, the transmission component 804 may be co-located with the reception component 802 in a transceiver.

The transmission component 804 may transmit, or the L1/L2 inter-cell mobility component 808 may cause the transmission component 804 to transmit, to a network node, capability information that indicates whether the apparatus 800 supports L1/L2 inter-cell mobility. The reception component 802 may receive, or the L1/L2 inter-cell mobility component 808 may cause the reception component 802 to receive, RRC signaling configuring one or more cells for L1/L2 inter-cell mobility based at least in part on the capability information. The reception component 802 may receive, or the L1/L2 inter-cell mobility component 808 may cause the reception component 802 to receive, L1/L2 signaling triggering inter-cell mobility based at least in part on the capability information indicating that the apparatus 800 supports L1/L2 inter-cell mobility.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a block diagram of an example apparatus 900 for wireless communication. The apparatus 900 may be a base station, or a base station may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 150. The communication manager 150 may include an L1/L2 inter-cell mobility component 908, among other examples.

In some aspects, the apparatus 900 may be configured to perform one or more operations described herein in connection with FIGS. 4A-4B and/or FIG. 4. Additionally, or alternatively, the apparatus 900 may be configured to perform one or more processes described herein, such as process 700 of FIG. 7. In some aspects, the apparatus 900 and/or one or more components shown in FIG. 9 may include one or more components of the base station described above in connection with FIG. 2. Additionally, or alternatively, one or more components shown in FIG. 9 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a demodulator, a MIMO detector, a receive processor, a controller/processor, a memory, or a combination thereof, of the base station described above in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modulator, a transmit MIMO processor, a transmit processor, a controller/processor, a memory, or a combination thereof, of the base station described above in connection with FIG. 2. In some aspects, the transmission component 904 may be co-located with the reception component 902 in a transceiver.

The reception component 902 may receive, or the L1/L2 inter-cell mobility component 908 may cause the reception component 902 to receive, from a UE, capability information that indicates whether the UE supports L1/L2 inter-cell mobility. The transmission component 904 may transmit, or the L1/L2 inter-cell mobility component 908 may cause the transmission component 904 to transmit, to the UE, RRC signaling configuring one or more cells for L1/L2 inter-cell mobility based at least in part on the capability information. The transmission component 904 may transmit, or the L1/L2 inter-cell mobility component 908 may cause the transmission component 904 to transmit, to the UE, L1/L2 signaling triggering inter-cell mobility for the UE based at least in part on the capability information indicating that the UE supports L1/L2 inter-cell mobility.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a UE, comprising: transmitting, to a network node, capability information that indicates whether the UE supports L1/L2 inter-cell mobility; receiving RRC signaling configuring one or more cells for L1/L2 inter-cell mobility based at least in part on the capability information; and receiving L1/L2 signaling triggering inter-cell mobility based at least in part on the capability information indicating that the UE supports L1/L2 inter-cell mobility.

Aspect 2: The method of Aspect 1, wherein the capability information further indicates whether the UE supports only a first L1/L2 inter-cell mobility technique, only a second L1/L2 inter-cell mobility technique, or both the first L1/L2 inter-cell mobility technique and the second L1/L2 inter-cell mobility technique.

Aspect 3: The method of Aspect 2, wherein support for the first L1/L2 inter-cell mobility technique enables the L1/L2 signaling to indicate that the UE is to communicate using a beam from a serving cell or a non-serving cell.

Aspect 4: The method of Aspect 3, wherein the capability information further indicates a maximum number of non-serving cells or a maximum number of beams supported by the UE based at least in part on the capability information indicating support for at least the first L1/L2 inter-cell mobility technique.

Aspect 5: The method of any of Aspects 2-4, wherein support for the second L1/L2 inter-cell mobility technique enables the L1/L2 signaling to indicate control information associated with a first cell set that includes one or more activated cells or a second cell set that includes one or more deactivated cells ready to be added to the first cell set.

Aspect 6: The method of Aspect 5, wherein the capability information further indicates a maximum number of serving cells or a maximum number of beams supported by the UE based at least in part on the capability information indicating support for at least the second L1/L2 inter-cell mobility technique.

Aspect 7: The method of any of Aspects 5-6, wherein the capability information further indicates a maximum number of serving cells or a maximum number of beams supported by the UE within an activated cell set based at least in part on the capability information indicating support for at least the second L1/L2 inter-cell mobility technique.

Aspect 8: The method of any of Aspects 1-7, wherein the capability information further indicates whether the UE supports using the L1/L2 signaling to indicate a PCell or a PSCell from a set including one or more activated cells.

Aspect 9: The method of Aspect 8, wherein the capability information further indicates a maximum number of activated cells that can be included in the set based at least in part on the capability information indicating that the UE supports using the L1/L2 signaling to indicate a PCell or a PSCell among the one or more activated cells.

Aspect 10: The method of any of Aspects 1-9, wherein the L1/L2 signaling includes DCI for L1 signaling or a MAC-CE for L2 signaling.

Aspect 11: A method of wireless communication performed by a network node, comprising: receiving, from a UE, capability information that indicates whether the UE supports L1/L2 inter-cell mobility; transmitting, to the UE, RRC signaling configuring one or more cells for L1/L2 inter-cell mobility based at least in part on the capability information; and transmitting, to the UE, L1/L2 signaling triggering inter-cell mobility for the UE based at least in part on the capability information indicating that the UE supports L1/L2 inter-cell mobility.

Aspect 12: The method of Aspect 11, wherein the capability information further indicates whether the UE supports only a first L1/L2 inter-cell mobility technique, only a second L1/L2 inter-cell mobility technique, or both the first L1/L2 inter-cell mobility technique and the second L1/L2 inter-cell mobility technique.

Aspect 13: The method of Aspect 12, wherein support for the first L1/L2 inter-cell mobility technique enables the L1/L2 signaling to indicate that the UE is to communicate using a beam from a serving cell or a non-serving cell.

Aspect 14: The method of Aspect 13, wherein the capability information further indicates a maximum number of non-serving cells or a maximum number of beams supported by the UE based at least in part on the capability information indicating support for at least the first L1/L2 inter-cell mobility technique.

Aspect 15: The method of any of Aspects 12-14, wherein support for the second L1/L2 inter-cell mobility technique enables the L1/L2 signaling to indicate control information associated with a first cell set that includes one or more activated cells or a second cell set that includes one or more deactivated cells ready to be added to the first cell set.

Aspect 16: The method of Aspect 15, wherein the capability information further indicates a maximum number of serving cells or a maximum number of beams supported by the UE based at least in part on the capability information indicating support for at least the second L1/L2 inter-cell mobility technique.

Aspect 17: The method of any of Aspects 15-17, wherein the capability information further indicates a maximum number of serving cells or a maximum number of beams supported by the UE within an activated cell set based at least in part on the capability information indicating support for at least the second L1/L2 inter-cell mobility technique.

Aspect 18: The method of any of Aspects 11-17, wherein the capability information further indicates whether the UE supports using the L1/L2 signaling to indicate a PCell or a PSCell from a set including one or more activated cells.

Aspect 19: The method of Aspect 18, wherein the capability information further indicates a maximum number of activated cells that can be included in the set based at least in part on the capability information indicating that the UE supports using the L1/L2 signaling to indicate a PCell or a PSCell among the one or more activated cells.

Aspect 20: The method of any of Aspects 11-19, wherein the L1/L2 signaling includes DCI for L1 signaling or a MAC-CE for L2 signaling.

Aspect 21: An apparatus for wireless communication at a device, comprising a processor; memory coupled with the processor; and instructions stored in the memory and executable by the processor to cause the apparatus to perform the method of any of Aspects 1-10.

Aspect 22: A device for wireless communication, comprising a memory and one or more processors coupled to the memory, the memory and the one or more processors configured to perform the method of any of Aspects 1-10.

Aspect 23: An apparatus for wireless communication, comprising at least one means for performing the method of any of Aspects 1-10.

Aspect 24: A non-transitory computer-readable medium storing code for wireless communication, the code comprising instructions executable by a processor to perform the method of any of Aspects 1-10.

Aspect 25: A non-transitory computer-readable medium storing a set of instructions for wireless communication, the set of instructions comprising one or more instructions that, when executed by one or more processors of a device, cause the device to perform the method of any of Aspects 1-10.

Aspect 26: An apparatus for wireless communication at a device, comprising a processor; memory coupled with the processor; and instructions stored in the memory and executable by the processor to cause the apparatus to perform the method of any of Aspects 11-10.

Aspect 27: A device for wireless communication, comprising a memory and one or more processors coupled to the memory, the memory and the one or more processors configured to perform the method of any of Aspects 11-10.

Aspect 28: An apparatus for wireless communication, comprising at least one means for performing the method of any of Aspects 11-10.

Aspect 29: A non-transitory computer-readable medium storing code for wireless communication, the code comprising instructions executable by a processor to perform the method of any of Aspects 11-10.

Aspect 30: A non-transitory computer-readable medium storing a set of instructions for wireless communication, the set of instructions comprising one or more instructions that, when executed by one or more processors of a device, cause the device to perform the method of any of Aspects 11-10.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
transmitting, to a network node, capability information that indicates whether the UE supports Layer 1 or Layer 2 (L1/L2) inter-cell mobility;
receiving radio resource control signaling configuring one or more cells for L1/L2 inter-cell mobility based at least in part on the capability information; and
receiving L1/L2 signaling triggering inter-cell mobility based at least in part on the capability information indicating that the UE supports L1/L2 inter-cell mobility.

2. The method of claim 1, wherein the capability information further indicates whether the UE supports only a first L1/L2 inter-cell mobility technique, only a second L1/L2 inter-cell mobility technique, or both the first L1/L2 inter-cell mobility technique and the second L1/L2 inter-cell mobility technique.

3. The method of claim 2, wherein support for the first L1/L2 inter-cell mobility technique enables the L1/L2 signaling to indicate that the UE is to communicate using a beam from a serving cell or a non-serving cell.

4. The method of claim 3, wherein the capability information further indicates a maximum number of non-serving cells or a maximum number of beams supported by the UE based at least in part on the capability information indicating support for at least the first L1/L2 inter-cell mobility technique.

5. The method of claim 2, wherein support for the second L1/L2 inter-cell mobility technique enables the L1/L2 signaling to indicate control information associated with a first cell set that includes one or more activated cells or a second cell set that includes one or more deactivated cells ready to be added to the first cell set.

6. The method of claim 5, wherein the capability information further indicates a maximum number of serving cells or a maximum number of beams supported by the UE based at least in part on the capability information indicating support for at least the second L1/L2 inter-cell mobility technique.

7. The method of claim 5, wherein the capability information further indicates a maximum number of serving cells or a maximum number of beams supported by the UE within an activated cell set based at least in part on the capability information indicating support for at least the second L1/L2 inter-cell mobility technique.

8. The method of claim 1, wherein the capability information further indicates whether the UE supports using the L1/L2 signaling to indicate a primary cell (PCell) or a primary secondary cell (PSCell) from a set including one or more activated cells.

9. The method of claim 8, wherein the capability information further indicates a maximum number of activated cells that can be included in the set based at least in part on the capability information indicating that the UE supports using the L1/L2 signaling to indicate a PCell or a PSCell among the one or more activated cells.

10. The method of claim 1, wherein the L1/L2 signaling includes downlink control information for L1 signaling or a medium access control control element for L2 signaling.

11. A method of wireless communication performed by a network node, comprising:
receiving, from a user equipment (UE), capability information that indicates whether the UE supports Layer 1 or Layer 2 (L1/L2) inter-cell mobility;
transmitting, to the UE, radio resource control signaling configuring one or more cells for L1/L2 inter-cell mobility based at least in part on the capability information; and
transmitting, to the UE, L1/L2 signaling triggering inter-cell mobility for the UE based at least in part on the capability information indicating that the UE supports L1/L2 inter-cell mobility.

12. The method of claim 11, wherein the capability information further indicates whether the UE supports only a first L1/L2 inter-cell mobility technique, only a second L1/L2 inter-cell mobility technique, or both the first L1/L2 inter-cell mobility technique and the second L1/L2 inter-cell mobility technique.

13. The method of claim 12, wherein support for the first L1/L2 inter-cell mobility technique enables the L1/L2 signaling to indicate that the UE is to communicate using a beam from a serving cell or a non-serving cell.

14. The method of claim 13, wherein the capability information further indicates a maximum number of non-serving cells or a maximum number of beams supported by the UE based at least in part on the capability information indicating support for at least the first L1/L2 inter-cell mobility technique.

15. The method of claim 12, wherein support for the second L1/L2 inter-cell mobility technique enables the L1/L2 signaling to indicate control information associated with a first cell set that includes one or more activated cells or a second cell set that includes one or more deactivated cells ready to be added to the first cell set.

16. The method of claim 15, wherein the capability information further indicates a maximum number of serving cells or a maximum number of beams supported by the UE based at least in part on the capability information indicating support for at least the second L1/L2 inter-cell mobility technique.

17. The method of claim 15, wherein the capability information further indicates a maximum number of serving cells or a maximum number of beams supported by the UE within an activated cell set based at least in part on the capability information indicating support for at least the second L1/L2 inter-cell mobility technique.

18. The method of claim 11, wherein the capability information further indicates whether the UE supports using the L1/L2 signaling to indicate a primary cell (PCell) or a primary secondary cell (PSCell) from a set including one or more activated cells.

19. The method of claim 18, wherein the capability information further indicates a maximum number of activated cells that can be included in the set based at least in part on the capability information indicating that the UE supports using the L1/L2 signaling to indicate a PCell or a PSCell among the one or more activated cells.

20. The method of claim 11, wherein the L1/L2 signaling includes downlink control information for L1 signaling or a medium access control control element for L2 signaling.

21. A user equipment (UE) for wireless communication, comprising:
a memory; and
one or more processors, coupled to the memory, configured to:
transmit, to a network node, capability information that indicates whether the UE supports Layer 1 or Layer 2 (L1/L2) inter-cell mobility;
receive radio resource control signaling configuring one or more cells for L1/L2 inter-cell mobility based at least in part on the capability information; and
receive L1/L2 signaling triggering inter-cell mobility based at least in part on the capability information indicating that the UE supports L1/L2 inter-cell mobility.

22. The UE of claim 21, wherein the capability information further indicates whether the UE supports only a first L1/L2 inter-cell mobility technique, only a second L1/L2 inter-cell mobility technique, or both the first L1/L2 inter-cell mobility technique and the second L1/L2 inter-cell mobility technique.

23. The UE of claim 22, wherein support for the first L1/L2 inter-cell mobility technique enables the L1/L2 signaling to indicate that the UE is to communicate using a beam from a serving cell or a non-serving cell.

24. The UE of claim 22, wherein support for the second L1/L2 inter-cell mobility technique enables the L1/L2 signaling to indicate control information associated with a first cell set that includes one or more activated cells or a second cell set that includes one or more deactivated cells ready to be added to the first cell set.

25. The UE of claim 21, wherein the capability information further indicates whether the UE supports using the L1/L2 signaling to indicate a primary cell or a primary secondary cell from a set including one or more activated cells.

26. A network node for wireless communication, comprising:
a memory; and
one or more processors, coupled to the memory, configured to:
receive, from a user equipment (UE), capability information that indicates whether the UE supports Layer 1 or Layer 2 (L1/L2) inter-cell mobility;
transmit, to the UE, radio resource control signaling configuring one or more cells for L1/L2 inter-cell mobility based at least in part on the capability information; and
transmit, to the UE, L1/L2 signaling triggering inter-cell mobility for the UE based at least in part on the capability information indicating that the UE supports L1/L2 inter-cell mobility.

27. The network node of claim 26, wherein the capability information further indicates whether the UE supports only a first L1/L2 inter-cell mobility technique, only a second L1/L2 inter-cell mobility technique, or both the first L1/L2 inter-cell mobility technique and the second L1/L2 inter-cell mobility technique.

28. The network node of claim 27, wherein support for the first L1/L2 inter-cell mobility technique enables the L1/L2 signaling to indicate that the UE is to communicate using a beam from a serving cell or a non-serving cell.

29. The network node of claim 27, wherein support for the second L1/L2 inter-cell mobility technique enables the L1/L2 signaling to indicate control information associated with a first cell set that includes one or more activated cells or a second cell set that includes one or more deactivated cells ready to be added to the first cell set.

30. The network node of claim 26, wherein the capability information further indicates whether the UE supports using the L1/L2 signaling to indicate a primary cell or a primary secondary cell from a set including one or more activated cells.
